(19) United States
(12) Patent Application Publication
(10) Pub. No.: US 2003/0009335 A1
(43) Pub. Date: Jan. 9, 2003

(54) Speech recognition with dynamic grammars

(76) Inventors: Johan Schalkwyk, Somerville, MA (US); Michael S. Phillips, Belmont, MA (US)

Correspondence Address: J. ROBIN ROHLICEK, J.D., PH.D., Fish & Richardson P.C., 225 Franklin Street, Boston, MA, 02110-2804, US

(21) Appl. No.: 09/906,390

(22) Filed: Jul. 16, 2001

Related U.S. Application Data
(60) Provisional application No. 60/303,049, filed on Jul. 5, 2001.

(51) Int. Cl. G10L 15/18

(52) U.S. Cl. 704/257

(57) ABSTRACT

The invention includes a method for speech recognition using cross-word contexts on dynamic grammars. The invention also includes a method for constructing a speech recognizer capable of speech recognition using cross-word contexts on dynamic grammars, by expanding a word of the main grammar into a corresponding network of sub-word units. The sub-word units are selected from the plurality of sub-word units based in part on a pronunciation of the word. Each sub-word unit has a permissible context including constraints on neighboring sub-word units within the corresponding network. The corresponding network is chosen to satisfy the constraints of the permissible context of each sub-word unit within the corresponding network. When the context of sub-word units would have apply to words provided by a runtime grammar, the expansion includes every sub-word unit that satisfies the permissible context, when compared to the corresponding network.

### CROSS-REFERENCE TO RELATED APPLICATIONS

This application claims the benefit of U.S. Provisional Application No. 60/______, entitled “SPEECH RECOGNITION WITH DYNAMIC GRAMMARS,” filed Jul. 5, 2001, which is hereby incorporated by reference.

### TECHNICAL FIELD

This invention relates to machine-based speech recognition, and more particularly to machine-based speech recognition with dynamic grammar, and machine-based speech recognition with context dependency.

### BACKGROUND

A speech recognition system maps sounds to words, typically by converting audio input, representing speech, to a sequence of phoneme or phones. The phoneme sequence is mapped to words based on one or more pronunciations per word. Words and acceptable sequences of words are defined in a main grammar. The chain of these mappings, from audio input through to acceptable sentences in a grammar, allows the speech recognition process to recognize speech within the audio input and to map the speech input to output values, such as the recognized text string and a confidence measure.

Context-dependent speech recognition uses more detailed context-specific modeling to improve speech recognition. These may include context-specific phonological rules or context specific acoustic models or both. Context-dependent models are models of how an utterance can occur in the audio input stream. Typically, a context-dependent model corresponds to a linguistic component of a word, such as a phoneme or a phone, as it might be uttered in speech—that is, in context. Because the corresponding component will usually have contexts in which it might occur, several context-dependent models can correspond to one component. One form of context-dependent speech recognition, therefore, maps audio input to context-dependent models, context-dependent models to pronunciations, and pronunciations to words.

The generation of the mappings from audio input to grammar is performed on a computer.

Finite State Machines

Finite state machines (FSMs) can encode linguistic models on a computer. An FSM can represent a system that accepts inputs and responds predictably by changing state among a finite number of possible states. Thus, an FSM can be a recognizer, if it meets the following criteria. An initial state receives input submissions. (A submission is an instance of an FSM's operation on an input string. Even if the same input string is submitted twice, there are two submissions.) For each submission, and at any given moment, an FSM has exactly one state that is current. A final state causes an FSM to finish operating on a submission. Since it is desirable that a recognizer halt and return a result for each submission, we require that an FSM recognizer have at least one final state. A state may be both initial and final.

A recognition attempt begins with a submission, which provides an input string. The FSM allocates a session to the submission. The session will return a result indicating acceptance or rejection of the input string.

A finite state transducer (FST) differs from a finite state acceptor (FSA) in that the FST arcs include output labels that are added to an output string for each submission. For an FST, each session will return an output string along with its result.

The session includes a current state and an input pointer. The current state is initialized to one of the machine's initial states. The input pointer is set to the beginning of the input string. The FSM evaluates the state transitions departing the current state as follows. A state transition has at least one input symbol and a next state, while the input string has a substring starting from a location defined by the input pointer. The input symbol has a defined pattern of characters that it will match. If the characters at the beginning of the substring qualify to match the input symbol's pattern, the transition accepts the input. Acceptance moves the current state to the transition's “next” state, and the input pointer moves to the first character beyond the portion matched by the pattern. In this manner, the transition “consumes” the matched portion. An epsilon transition has the empty string “” (also known as “epsilon” or “eps”) for its input symbol. An epsilon transition accepts without consuming any input. One use of an epsilon transition is, in effect, to join a second state (pointed to by the epsilon transition) to a first state, since any path that reaches the first state can also reach the second state on identical inputs.

If the transition has an output symbol, the output is put out during acceptance.

Evaluation of the state transitions begins anew from the current state. The session becomes stuck if no transitions from the current state accept the input. This can happen if there are no transitions to match the input; or, in the absence of epsilon transitions, this can happen if the input string is entirely consumed, so that there is no input to match the transitions. The session halts (a different and more constructive result than becoming stuck) when the current state is a final state. The recognition attempt succeeds if the session halts on a final state with the input string entirely consumed. Otherwise, the recognition attempt fails.

A FSM is sometimes described as a network or graph. States correspond to nodes of a graph, while arcs correspond to directed edges of a graph.

### SUMMARY

In general, in one aspect, the invention is a method for a speech recognition system. The method includes representing a word in a grammar in terms of context-dependent models to include cross-word context models for multiple different expansions of a placeholder in the grammar.

Preferred embodiments include one or more of the following features. The method may include replacing the placeholder with a second grammar and expanding words of the second grammar to include cross-word context models. The method may further include accepting a specification of the second grammar at runtime; selecting the second grammar at runtime from among a plurality of grammars provided at design time; or selecting the second grammar after design time. The method may still further include adding a word to the second grammar at runtime.

In general, in another aspect, the invention is a method for a speech recognition system. The method includes representing a word in a grammar in terms of context-dependent models to include cross-word context models matching a set of possible expansions of a placeholder in the grammar.

Preferred embodiments include one or more of the following features. The set of possible expansions may include all possible expansions of the placeholder using context-dependent models. In another embodiment, the set of possible expansions may include context-dependent models.

In general, in yet another aspect, the invention is a method for speech recognition. The method includes joining a first expanded grammar and a second expanded grammar at a junction. The first expanded grammar includes a first context-dependent model whose context applies to a second context-dependent model in the second expanded grammar. The first expanded grammar also includes a third context-dependent model prepared to receive at the junction a third expanded grammar. The third expanded grammar matches the context of the third context-dependent model but does not match the context of the first context-dependent model.

Preferred embodiments include one or more of the following features. The method may include expanding the first expanded grammar from a main grammar, and expanding the second expanded grammar from a runtime grammar. Alternatively, the method may include expanding the first expanded grammar from a first runtime grammar and the second expanded grammar from a second runtime grammar.

In general, in still another aspect, the invention is a method for constructing a speech recognition system. The method includes representing a word in a grammar in terms of context-dependent models, to include cross-word context models required for multiple different expansions of a placeholder in the grammar. The method further includes replacing the placeholder with a runtime grammar and expanding the words of the runtime grammar to include cross-word context models.

Preferred embodiments include one or more of the following features. The method may include selecting the runtime grammar based on a characteristic of a speaker whose speech is to be recognized by the speech recognition system. The characteristic of the speaker may depend on a record of the speaker's identity.

The invention includes one or more of the following advantages.

It is not always desirable to prepare every step of the speech recognizer in advance of deploying the speech recognition system. Preparing the mappings, from audio input through to acceptable sentences in a grammar, consumes computing resources. A total preparation may be an inefficient use of these resources. For instance, portions of a mapping may never be needed, so the resources used to prepare these portions may be wasted. Also, for large grammars, the mappings may require large amounts of storage. The processing time may also increase with grammar size.

It may be desirable to leave portions of the grammar incomplete until runtime. Not every component of the grammar may be knowable at design time. A dynamic grammar adds flexibility to the speech recognition system. For instance, the speech recognition system can adapt, for instance, to the characteristics, including needs or identities, of specific users. A dynamic grammar can also usefully constrain the range of speech that the speech recognition system must be prepared to recognize, by expanding or contracting the grammar as necessary.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A is a block diagram of a speech recognition system.

FIG. 1B is a block diagram of a computing platform.

FIG. 2A is a flowchart of a process including a design-time mode and a runtime mode.

FIG. 2B is a block diagram of a recognizer process.

FIG. 3A is a block diagram of a transducer combination process.

FIG. 3B is a block diagram of basic grammar structures.

FIG. 4 is a block diagram of design-time preparations.

FIG. 5 is a block diagram of a finite state machine optimization of a lexicon.

FIG. 6 is a block diagram of a context-factoring example.

FIG. 7 is a block diagram of a grammar-to-phoneme compiler.

FIG. 8A is a block diagram of a composition process.

FIG. 8B is a block diagram of an example of a finite state machine rewrite.

FIG. 9 is a flowchart of a known finite state machine composition process.

FIG. 10 is a flowchart of a finite state machine composition process.

FIG. 11 is a block diagram of a finite state machine composition process, with examples.

FIG. 12 illustrates deriving context-dependent models.

Like reference symbols in the various drawings indicate like elements.

### DETAILED DESCRIPTION

One approach to context-dependent speech recognition maps audio input to context-dependent models, context-dependent models to pronunciations, and pronunciations to words. In the present embodiment, finite state machines represent words, pronunciations, variations in pronunciation, and context-dependent models. The necessary mappings between them are encoded in a single FSM recognizer by constructing the recognizer from smaller machines using FSM composition.

Contexts at the boundary of a dynamic grammar, as will be explained in more detail, are not fully known in advance of knowing the dynamic grammar. The invention allows speech recognition using context-dependent models, even when contexts span boundaries between a main grammar (known at design-time) and dynamic portions (provided later).

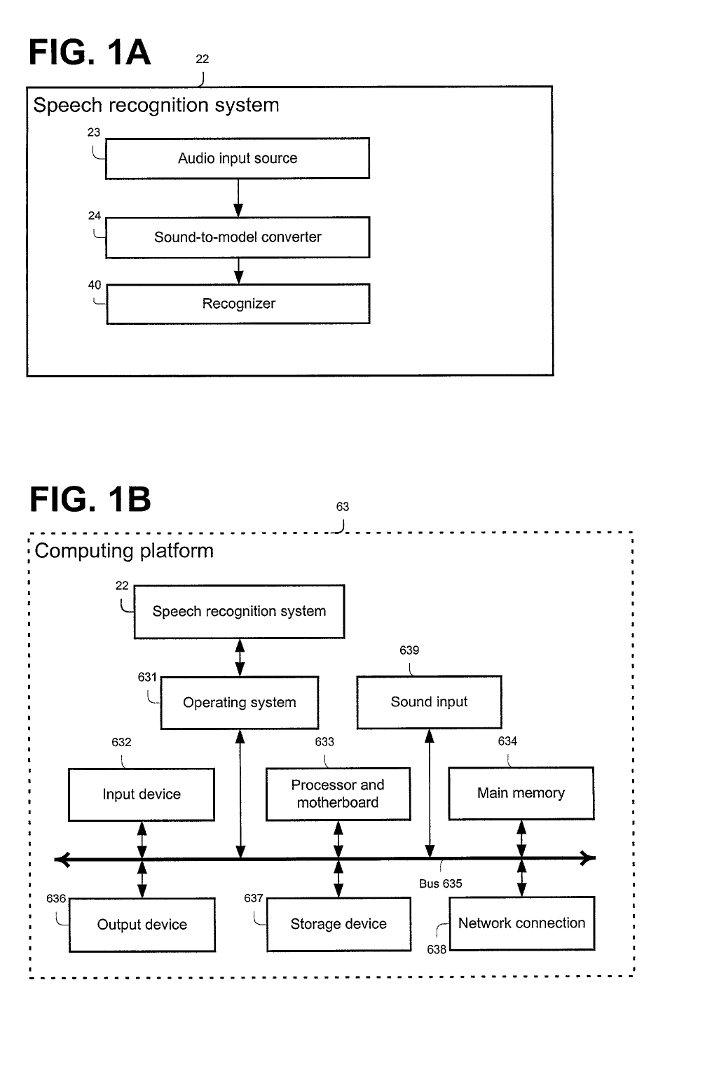

In one embodiment, and with regard to FIG. 1A, a speech recognition system 22 includes an audio input source 23, a sound-to-model converter 24, and a recognizer 40.

The audio input source 23 provides a sound signal (not shown) in digitized form to the sound-to-phoneme converter 24. The sound signal may capture speech of a live speaker whose voice is sampled by a microphone. The sampled voice is then digitized to create the sound signal. Alternatively, the sound signal may be derived from a pre-recorded source.

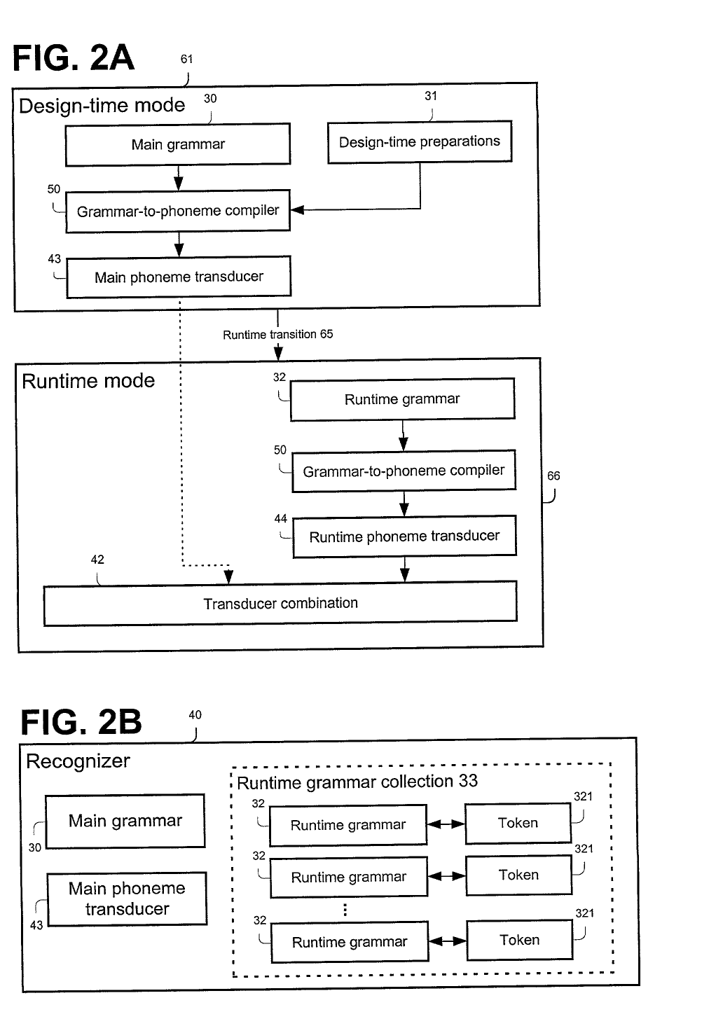

As shown in FIG. 2A, in a design-time mode 61, a main grammar 30, which contains words and sentences to recognize, becomes a main transducer 43 that includes context-dependent phoneme models. Broadly speaking, the main transducer 43 can process phoneme strings (such as provided by the sound-to-phoneme converter 24) into the words and sentences of the main grammar 30.

The words to be recognized, i.e. the main grammar 30, might not always be known during the design-time mode 61. We may wish to recognize words and sentences that are provided after design time; this requires a “dynamic” grammar.

A dynamic portion of the grammar may be provided as a runtime grammar 32. There is a number of ways in which a runtime grammar 32 may be provided after design time. For one, a runtime grammar 32 may need completing by providing some of its words at runtime. Alternatively, a runtime grammar 32 might not be available to the design-time mode 61 as part of a design choice, perhaps to save space in the main grammar or to allow for simple flexibility among a finite number of choices. For instance, for an application that recognizes speech to sell airline ticket from one to three months in advance, a runtime grammar 32 might be provided to recognize the names of the next three calendar months. This runtime grammar 32 would vary with the current date of the runtime session. As a further example, the runtime grammar 32 could have been stored in a database along with a variety of other runtime grammars 32 and not retrieved until some runtime condition specified its selection from among the multiple runtime grammars 32. The runtime condition may be a characteristic of the speaker, such as the speaker's identity, so that the runtime grammar 32 is selected to suit the individual speaker.

After the speech recognition system 22 transitions to a runtime mode 66, a runtime grammar 32 is converted to a runtime transducer 44. A transducer combination process 42 then integrates the runtime transducer 44 and the main transducer 43, using phoneme context models even across boundaries between words in the main grammar 30 and words in the runtime grammar 32.

Computing Environment

FIG. 1B shows a speech recognition system 22 on a computing platform 63.

The speech recognition system 22 contains computer instructions and runs on an operating system 631. The operating system 631 is a software process, or set of computer instructions, resident in either main memory 634 or a non-volatile storage device 637 or both. A processor 633 can access main memory 634 and the non-volatile storage device 637 to execute the computer instructions that comprise the operating system 631 and the speech recognition system 22.

A user interacts with the computing platform via an input device 632 and an output device 636. Possible input devices 632 include a keyboard, a microphone, a touch-sensitive screen, and a pointing device such as a mouse, while possible output devices 636 include a display screen, a speaker, and a printer.

The non-volatile storage device 637 includes a computer-writable and computer-readable medium, such as a disk drive. A bus 635 interconnects the processor and motherboard 633, the input device 632, the output device 636, the storage device 637, main memory 634, and optional network connection 638. The network connection 638 includes a device and software driver to provide network functionality, such as an Ethernet card configured to run TCP/IP, for example.

The recognizer 40 may be written in the programming language C. The C code of the recognizer 40 is compiled into lower-level code, such as machine code, for execution on a computing platform 63. Some components of the recognizer 40 may be written in other languages such as C++ and incorporated into the main body of software code via component interoperability standards, as is also known in the art. In the Microsoft Windows computing platform, for example, component interoperability standards include COM (Common Object Model) and OLE (Object Linking and Embedding).

Design-Time Mode

FIG. 2A shows a design-time mode 61, which represents a state of the recognizer 40 before it is deployed to a runtime environment. A runtime transition 65 represents the transition to a runtime mode 66.

The design-time mode 61 includes a main grammar 30, a grammar-to-phoneme compiler 50, a design-time preparations process 71, and a main transducer 43. As is shown in FIG. 2B, the main transducer 43 is included in the recognizer 40.

Main Grammar

Broadly speaking, the main grammar 30 specifies the words and sentences that the recognizer 40 will accept.

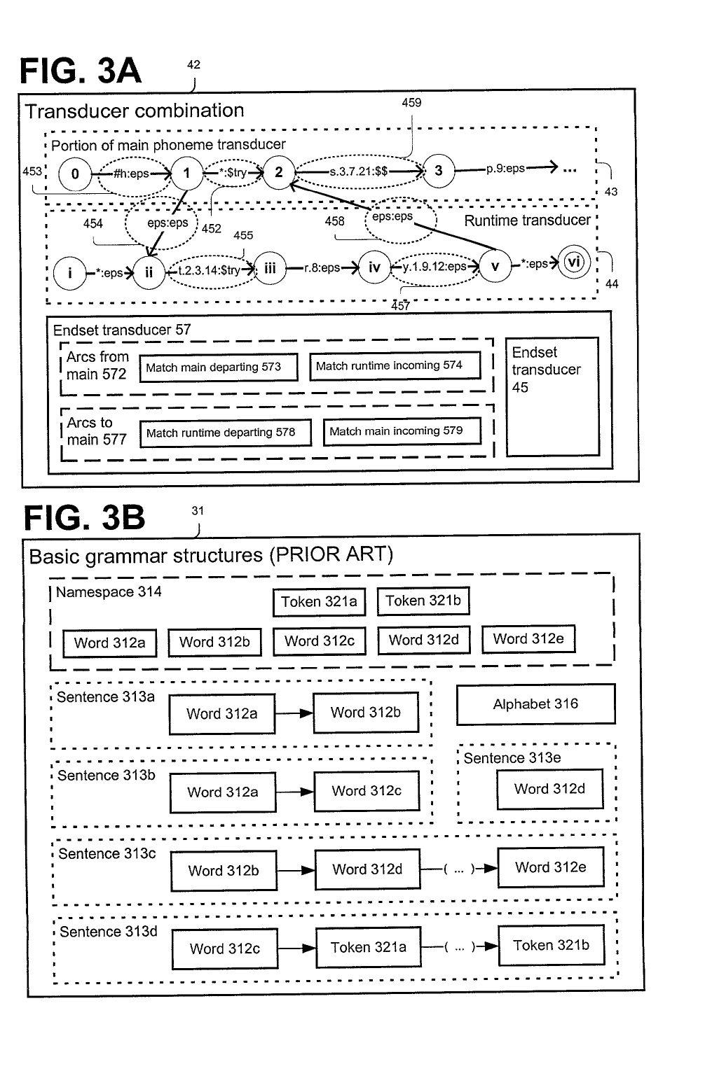

Some general properties of a grammar are illustrated in FIG. 3B. As will be explained in more detail, subgrammars can be integrated into the main grammar 30. General grammar properties are shared by the main grammar and its subgrammars.

A main grammar 30 and a runtime grammar 32 (see FIG. 2B) have properties in common, some of which are shown in FIG. 3B.

An alphabet 316 is a set of symbols (not shown), which can be used to spell a word 312 or token 321.

A word 312 is an arrangement of symbols from the alphabet 316; the arrangement is called the spelling (not shown) of the word 312. Spelling is known in the art. Not all symbols in the alphabet 316 need be used in words 312; some may have special purposes, including notation.

A sequence of one or more words 312 forms a sentence 313. A word 312 may appear in more than one sentence 313, as shown by sentences 313a and 313b of FIG. 3, which both contain word 312a. The spelling of a word 312 is not necessarily unique: two identical spellings may be distinguished by their meaning.

Like a word 312, a token 321 is an arrangement of symbols from the alphabet 316. The collection of all words 312 and tokens 321 in a grammar is called the namespace 314. Unlike a word 312, each token 321 has a unique spelling within the namespace 314. A word 312 usually has semantic meaning in some domain (for instance, the domain of speech that the speech recognition system 22 is designed to recognize), while a token 321 is usually a placeholder for which some other entity can be substituted.

Design-Time Preparations

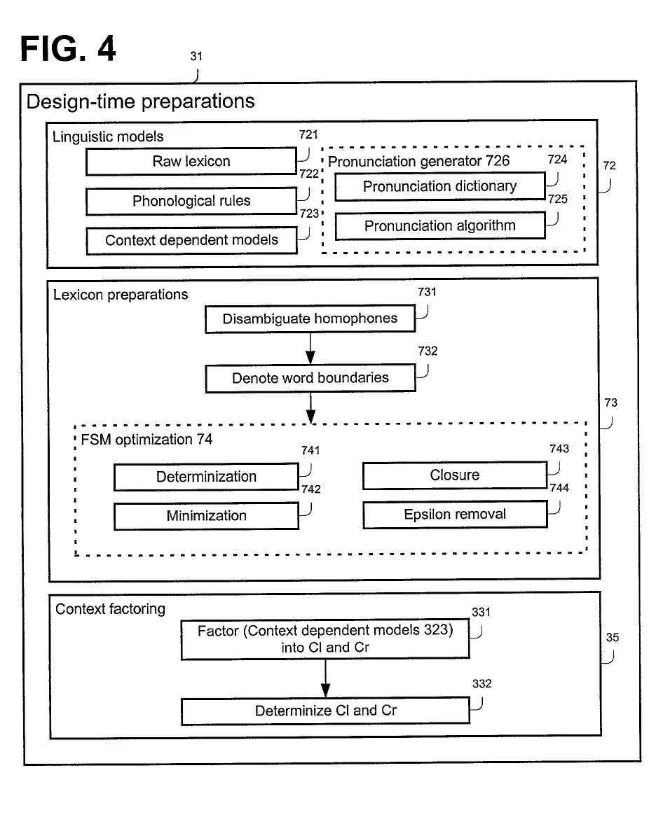

With reference to FIG. 4, design-time preparations 71 include providing linguistic models 72, lexicon preparations 73, and context factoring 35.

The linguistic models 72 are constructed by processes that include a raw lexicon 721, called “raw” here to distinguish its initial form from the lexicon produced by lexicon preparations 73, as well as phonological rules 722, context dependent models 723, a pronunciation dictionary 724, and a pronunciation algorithm 725.

Raw Lexicon

The raw lexicon 721 contains pronunciation rules for words in the main grammar 30. The rules are encoded in an FSM transducer by using input symbols on the arcs of the FSM drawn from a phonemic alphabet. The output of the raw lexicon transducer 721 includes words in the main grammar 30 and words provided by runtime grammars 32.

Context Dependent Models

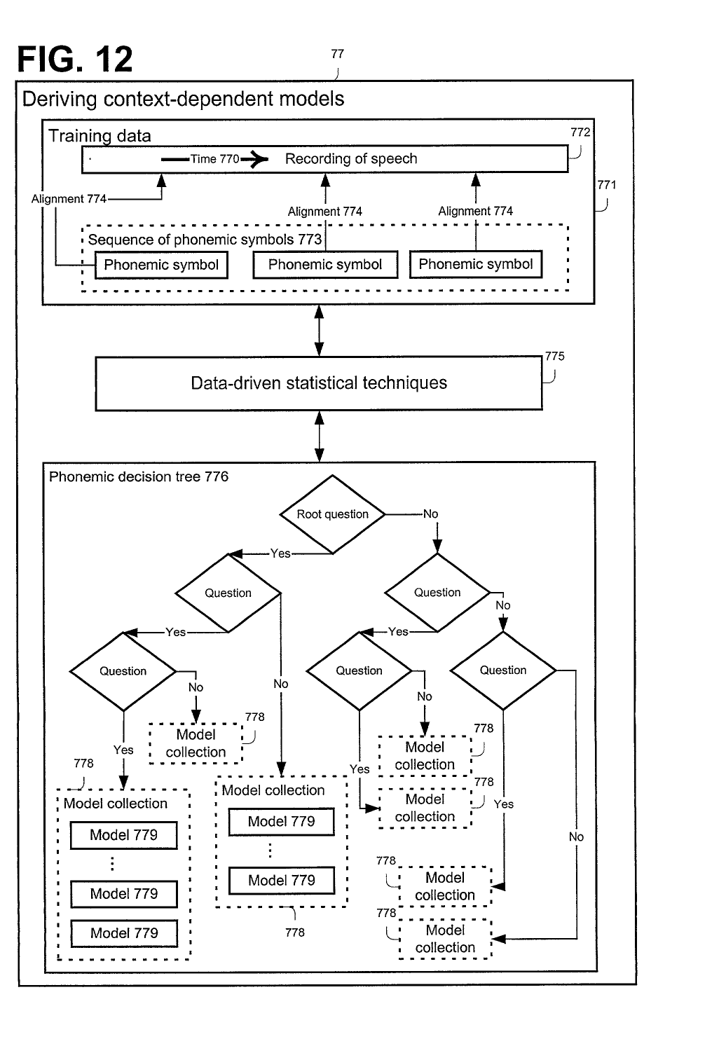

The context dependent models 723 model the sound of phonemes spoken in real speech. FIG. 12 shows elements in a process (77) to derive the context dependent models 723. Context dependent models 723 are a form of sub-word units.

The context dependent models 723 are derived empirically from training data 771 using data-driven statistical techniques 775 such as clustering. The training data 771 includes recordings 772 of a variety of utterances selected to be representative of speech that will be presented to the speech recognition system 22. Selecting training data 771 is complex and subjective. Too little training data 771 will not provide sufficient grounds for statistical distinction between two different yet acoustically similar phonemes, or between contextual changes for a given phoneme. On the other hand, too much training data 771 can cause the system to infer undesirable statistical patterns, for example, patterns that happen to appear in the training data but are not characteristic of the general range of input.

A recording 772 has a time measure 770. Alignments 774 relate a sequence of phonemic symbols 773 to the time measure 770 within the recording 772, to indicate the portions of the recording 772 that represents an utterance of the phonemic symbols 773.

For a given phoneme, its phonological context describes permissible neighbors that can appear in valid sequences of phonemes in speech. A phonological context disregards epsilon. If an epsilon transition occurs between a given phoneme and a neighbor, the phonological context measures the distance to the neighbor as though the epsilon were not there. The neighbors can occur both before and after in time, notated as left and right, respectively. There are several ways to model context, including tri-phonic, penta-phonic, and tree-based models. This embodiment uses tri-phonic contexts with phonemes, which weigh three phonemes at a time: a current phoneme and the phonemes to the left and right.

For a given phoneme, the data-driven statistical techniques 775 derive a phonemic decision tree 776, which categorizes all possible context models for the given phoneme according to a tree of questions. The questions are Boolean-valued (yes/no) tests that can be applied to the given phoneme and its context. An example question is “Is it a vowel?”, although the questions are phrased in machine-readable code. For a given branch of the tree, traversing outward from the root, subsequent questions refine earlier questions. Thus, a subsequent question for the earlier question might be “Is it a front vowel?”

The data-driven statistical techniques 775 select a question as the most distinctive question (according to a statistical measure) and label it the root question. Subsequent questions are added as children of the root question. The recursive addition of questions can continue automatically to some predetermined threshold of statistical confidence. However, the structure of the phonemic decision tree 776—that is, the infrastructure of the questions—may also be tuned by human designers.

The phonemic decision tree 776 is a binary tree, reflecting the Boolean values of the questions. The leaves of the tree are model collections 778, which contain zero or more models 779. Initially the model collections 778 contain models 779 detected in the training data 771 by the data-driven statistical techniques 775. The context dependent models derivation process 77 adds models 779 that do not occur in the training data 771 to the phonemic decision tree 776, only after all questions have been added by the traversing the tree for each model 779. Models 779 are added by evaluating the question nodes against the model 779, then following the corresponding branches recursively until reaching a model collection 778 that receives the model 779.

Like the raw lexicon 721, context dependent models 723 are also encoded in an FSM transducer. The transducer maps sequences of names of context-dependent phone models to the corresponding phone sequence. The topology of this transducer is determined by the kind of context dependency used in modeling. The input symbols of a tri-phonic phonemic context FSM use the phonemic alphabet with additional characters to represent positional information or other information “tags” such as end-of-word, end-of-sentence, or a homophonic variant. Input symbols are of the form “x/y_z”, where x represents the current phoneme in the input string, y and z are left and right neighbors, respectively. In this case, the center character x is never a tag character. Positional characters include “#h” (which indicates a sentence beginning) or “h#” (sentence end). Homophonic characters include “#1”, “#2”, etc. A word-boundary character is “.wb”.

Phonological Rules

Phonological rules 722 are also encoded in an FSM transducer. Phonological rules 722 introduce variant pronunciations as well as phonetic realizations of phonemes. Unlike a lexicon L, which maps phoneme sequences to words, P affects phoneme sequences that are not necessarily entire words. P's rules are contextual, and the contexts may apply across word boundaries. In practice, though, there can be benefits to expressing any phonological rules that are context-dependent in the context dependent models 723 instead of the phonological rules 722. This centralizes all contextual concerns into a single machine and also simplifies the role of the phonological transducer 57.

The input symbols of the phonological rules 722 FSM use the same extended phonemic alphabet and the same matching rules as the context dependent models 723 FSM, but the contexts of the phonological rules are not restricted to triplets, and the phonological rules 722 may rewrite their inputs with one more characters from the pure phonemic alphabet.

The pronunciation generator 726 offers a way to find a pronunciation of a word. The pronunciation generator 726 therefore allows the use of dynamic grammars that are not constrained against the vocabulary of the lexicons 721 and 52. The pronunciation generator 726 takes input in the form of a word and returns a sequence of phonemes. The sequence of phonemes is a pronunciation of the input word. The pronunciation generator 726 uses a pronunciation dictionary 724 and a pronunciation algorithm 725. The pronunciation dictionary 724 provides known phonemic spellings of words. The pronunciation algorithm 725 contains rules hand-crafted to a phoneme set known to be acceptable to the context dependent models 723. Basing the pronunciation algorithm 725 on this phoneme set insures against collisions between algorithmic guesses and impermissible contexts. The pronunciation algorithm 725 is tuned by its human designers to meet subjective parameters for acceptability; in English, for example, which is not an especially phonetic language, the parameters can be quite approximate.

The pronunciation generator 726 works as follows. The pronunciation generator 726 first consults the pronunciation dictionary 724 to see if a known pronunciation for the input words exists. If so, the pronunciation generator 726 returns the pronunciation; otherwise, the pronunciation generator 726 returns the best-guess produced by passing the input word to the pronunciation algorithm 725. More than one pronunciation may be acceptable, and thus more than one pronunciation may be returned.

Lexicon Preparations

Lexicon preparations 73 include a disambiguate homophones process 731, a denote word boundaries process 732, and an FSM optimization process 74. The disambiguate homophones process 731 introduces auxiliary symbols into the raw lexicon 721 to denote two words that sound alike. An example in English is “red” and “read”, which both map to the phonemes /r eh d/. This sort of homophone ambiguity can cause infinite loops in the determinization of the raw lexicon 721. Auxiliary notation, such as /r eh d #1/ for red and /r eh d #2/ for read, can remove the ambiguity. The auxiliary notation can be removed after determinization, for instance by extending the function of the right transducer Cr 55 with self-looping transitions on each such auxiliary symbol. The self-looping transitions would consume the auxiliary symbols.

The denote word boundaries process 732 also adds an auxiliary symbol: “.wb” indicates a word boundary.

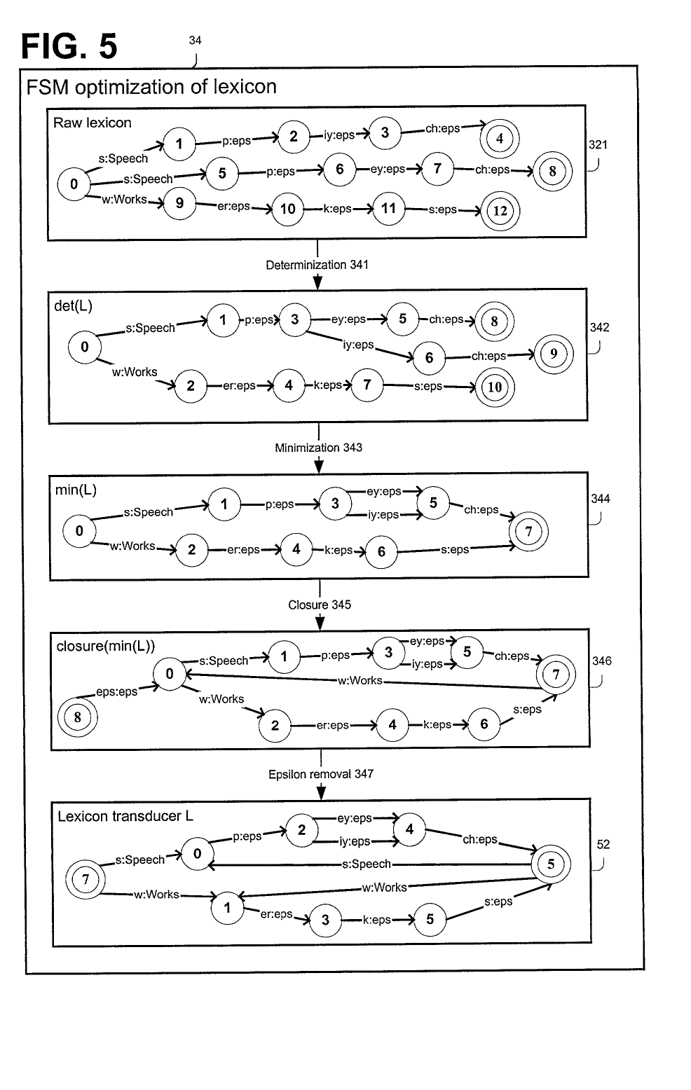

The FSM optimization process 74 performs FSM algorithms for determinization 741, minimization 743, closure 745, and epsilon removal 747 on the raw lexicon 721 FSM. FIG. 5 illustrates the effects of these operations on an example raw lexicon 721. The output of the FSM optimization process 74 is the lexicon transducer L 52, ready for composition with the main grammar 30.

Context Factoring

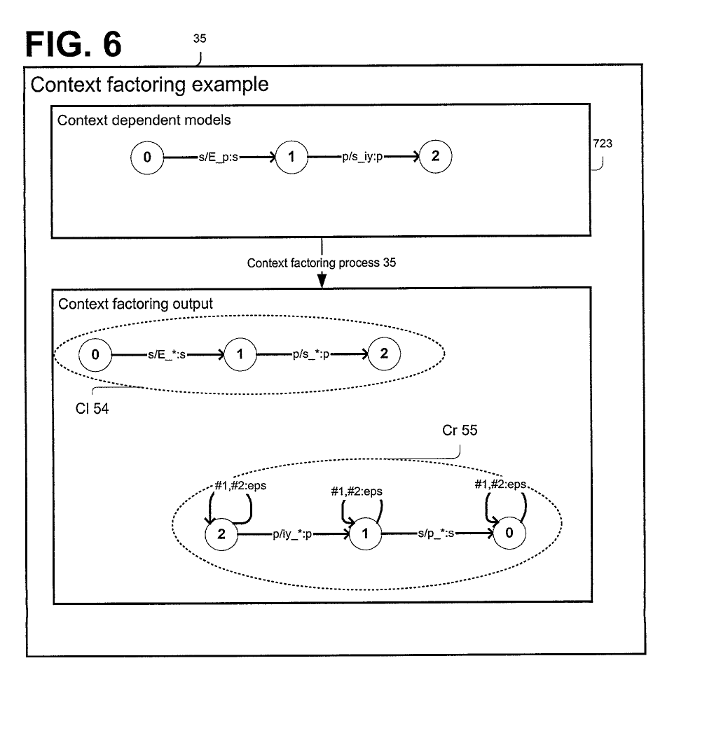

With regard to FIG. 6, the context factoring process 35 derives (step 331) the left transducer Cl 54 and the right transducer Cr 55 from the FSM transducer for the context dependent models 723. The right transducer Cr 55 is extended to include self-looping transitions on each such homophone disambiguation symbol. Both the left transducer Cl 54 and the right transducer Cr 55 may include a phonological symbol indicating unknown context, as for instance may exist for a neighbor of a runtime grammar 32. Following the derivation, the context factoring process 35 determinizes the transducers 54 and 55. Among other reasons, determinizing improves performance of the transducers 54 and 55 after composition.

Grammar-to-Phoneme Compiler

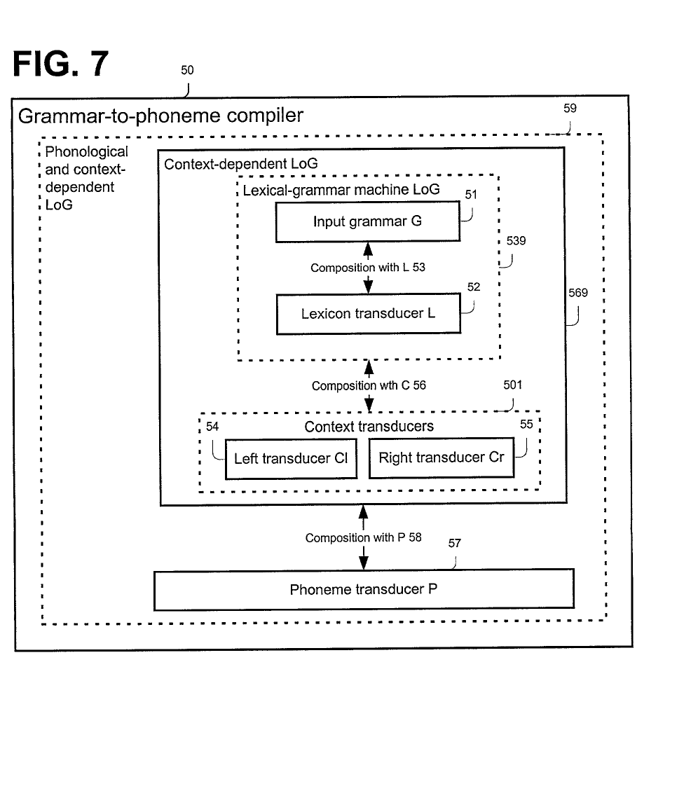

Referring now to FIG. 7, the grammar-to-phoneme compiler 50 takes input in the form of an input grammar G 51 and returns a phonological and context-dependent lexical-grammar machine 59, also called “PoCoLoG” for the FSM compositions it contains. The grammar-to-phoneme compiler 50 uses linguistic models encoded as FSMs, including: a lexicon transducer L 52; a set of context transducers 501 that includes a left transducer Cl 54 and a right transducer Cr 55; and a phoneme transducer 57. As will be explained in more detail, the grammar-to-phoneme compiler 50 uses a chain of compositions, passing the output of one as input to the next. The chain includes a composition with L 53, a composition with C 56, and a composition with P 58.

Composition of G With L

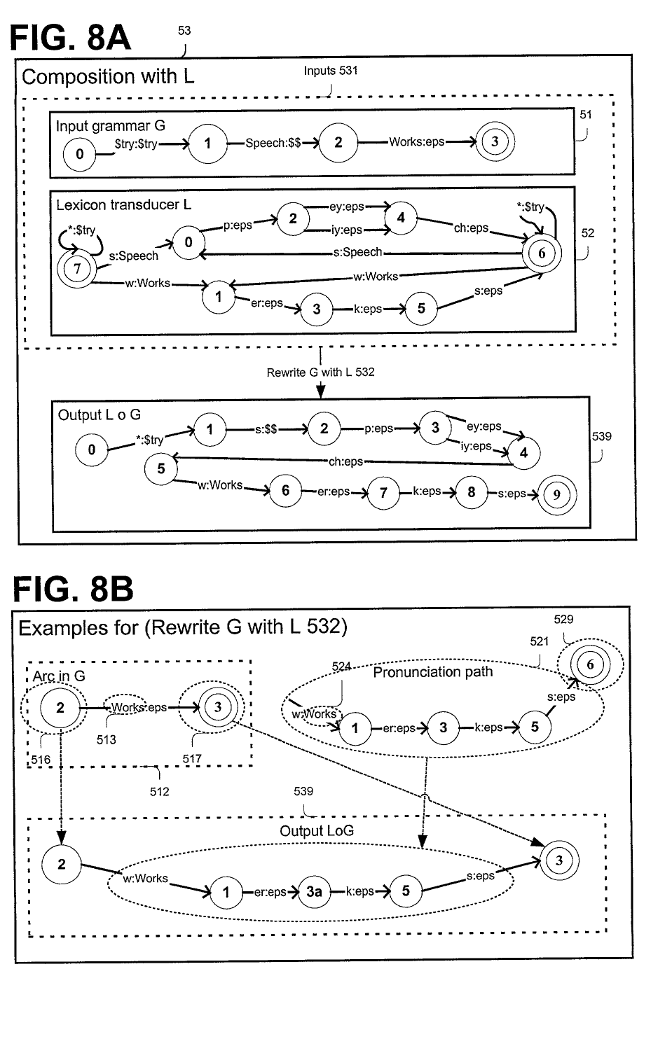

With regard to FIG. 8A, the composition with L 53 produces an FSM that takes in phonemes and turns out words. More specifically, the composition with L 53 composes (step 532) an input grammar G 51 with the lexicon transducer L 52. The input grammar G 51 may include the main grammar 30, which is shown in the design-time mode of FIG. 2A, or a runtime grammar 32 from the runtime grammar collection 33, which is shown in the runtime mode 66, also in FIG. 2A.

FIG. 8B illustrates an example of the composition with L process 53 in action. For clarity, FIG. 8B uses subsets of the example machines shown in FIG. 8A. An arc in G 512 has an input symbol 513, a departed state 516, and a next state 517. A pronunciation path 521 in L 52 contains a first arc having an output symbol 524 and an input symbols that represents a first phoneme in a pronunciation of a word represented in the output symbol 524. The pronunciation path 521 optionally contains subsequent states and arcs after the first arc, daisy-chained in the manner shown in FIG. 8B. Subsequent arcs have output symbols of “eps” if they exist. The final arc in the pronunciation path 521 points to a final state 529 in L, although the final state 529 is not included in the pronunciation path 521. The final state 529, by being final, denotes a word boundary. Thus, the sequence of arcs in the pronunciation path 521 corresponds to a word, as follows: the sequence's first arc outputs a word; no subsequent arcs output anything but “eps”; the first arc accepts a first phoneme of a word's pronunciation; and subsequent arcs contribute subsequent phonemes until the final arc, which points to a word boundary which terminates the word.

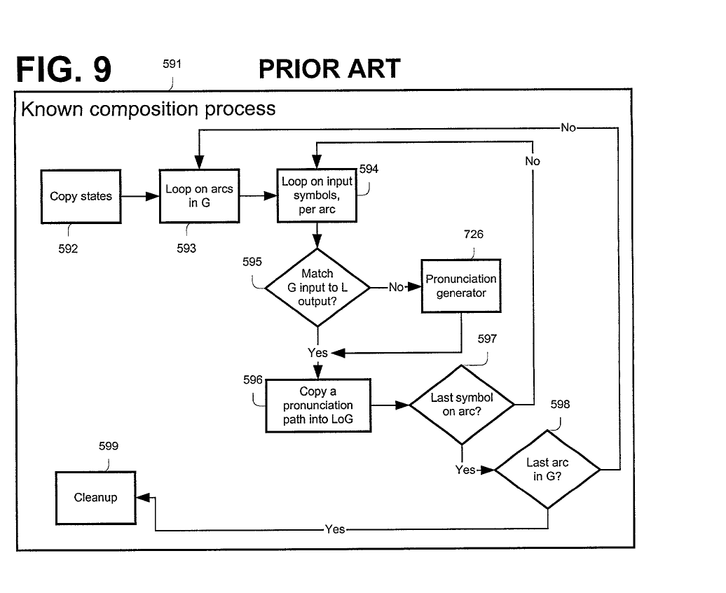

The resulting FSM 539, which can be denoted LoG, is a rewrite of G 51 by L 52. The composition according to the following known composition process 591 is illustrated in FIG. 9. The known composition process 591 initializes an empty output FSM 539 and copies all states of G into the empty output FSM 539 (step 592). The known composition process 591 loops first through one arc 512 in G 51 at a time (step 593). In a sub-loop for each input symbol 513 on the current arc 512 (step 594), the known composition process 591 compares each input symbol 513 to each output symbol 524 on arcs in L 52 (step 595). When this comparison 595 yields a match, the known composition process 591 copies each matching pronunciation path 521 from L 52 into LoG 539 (step 596). The pronunciation path 521 corresponds to an acceptable pronunciation of the input symbol 513.

The pronunciation path 521 begins with the arc in L whose output symbol matched the input symbol and continues until a word boundary is matched. In the example of FIG. 8B, the input symbol 513 is “Works,” while the pronunciation path 521 contains arcs having input symbols /w/, /er/, /k/, and /s/ respectively. The first arc on the pronunciation path 521 has an output symbol 524 of “Works” which matches the input symbol 513 of the arc in G 512. Any intermediate states on the path are copied into LoG 539 as well; in the example, these include states labeled “1”, “3”, and “5” in L, which are mapped to states labeled “1”, “3a”, and “5” in the output LoG 539. Additional minimization and other optimization steps may be performed on LoG 539 which may rename its states to achieve the final naming shown in FIG. 8A, where the internal states of the pronunciation path 521 are named 6, 7, and 8, respectively.

The first arc in the pronunciation path 521 when written into LoG 539 departs from the same state in LoG 539 that the original departing state 516 in G maps to. In terms of the example of FIG. 8B, the state labeled “2” of LoG 539 has a departing arc with label “w:Works” that corresponds to the first arc in path 521. Similarly, the final arc in the pronunciation path 521 points to the same state in LoG 539 that the original next state 517 arc maps to. Again put in terms of the example of FIG. 8B, the state labeled “3” of LoG 539 has an incoming arc with label “s:eps” that corresponds to the last arc in path 521. The state labeled “3” happens to be a final state in LoG 539 because that was its role in G 51 in this example, as shown in G 51 of FIG. 8A, but in the general case the state labeled “3” could be any state in G 51.

When the comparison 595 does not yield a match, the known composition process 591 can invoke a pronunciation generator 726 to find a pronunciation and convert the pronunciation to a representation as a pronunciation path 521.

The known composition process 591 continues looping on symbols (step 597) and arcs (step 598) until all arcs and symbols in G have been processed, at which time the known composition process 591 may apply FSM operations to LoG 539 such as minimization, determinization, and epsilon removal to normalize the LoG 539 FSM (step 599).

The composition with L process 53 is similar to the composition process 591 but has at least two differences.

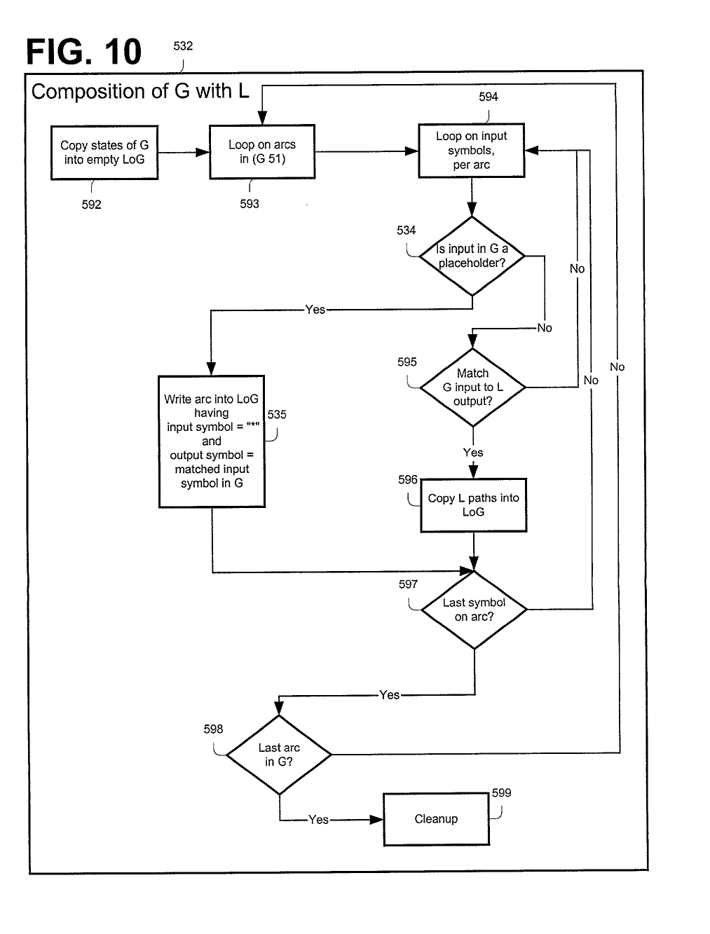

Referring now to FIG. 10, one difference is that before comparing the input symbol 513 with output symbols 524 of arcs in L 52 (step 595), the composition with L process 53 checks whether the input symbol 513 matches a token 321 in the runtime grammar collection 33 (step 534). A second difference is that if the input symbol 513 matches such a token 321, the composition with L process 53 writes a one-arc path into LoG 539. The sole arc has the phonemic symbol for runtime class 735 as its input symbol, which is “*”, and the value of the token 321 as its output symbol. (The symbol “*” is a placeholder that helps manage ambiguous context at the border of a runtime grammar 32.) The composition with L process 53 then returns to looping on input symbols (step 597).

When the known composition process 591 has processed all arcs in G, LoG 539 accepts input strings in the form that L does: phonemes. Acceptance of a phoneme string by LoG 539 is precisely the acceptance one would see if the string were first submitted to L 52, which transduces phonemes to words, and the words were then submitted to G 51 as input. The acceptance behavior and output of the transducer LoG 539 will match the acceptance behavior and output of G 51.

Composition with C

The grammar-to-phoneme compiler 50 uses the composition with C process 56 to convert a phoneme-accepting transducer to a transducer that accepts context-dependent models. Specifically, the composition with C process 56 factors the context dependent models FSM 723 into FSMs for right and left context, then uses these FSMs to rewrite LoG 539, where LoG 539 may be based on the main grammar 30 or a runtime grammar 32.

The result of the composition with C process 56 is an FSM transducer that can use context-dependent models as input and has the outputs and word-acceptance behavior of the underlying grammar in LoG 539. Thus, the chain of recognition is extended from grammar down to context-dependent models. The composition with C process 56 also constrains the number of phoneme combinations that must be examined when considering phonemic context across the edge of a runtime grammar 32. Constraining the number of combinations improves runtime performance of the recognizer 40.

More specifically, the composition with C process 56 accepts the LoG machine 539 as input; composes the reverse of the machine 539 with the right transducer Cr 55 to form a machine Cr o rev(LoG), then reverses Cr o rev(LoG) and composes it with Cl. This final context-dependent LoG machine 569 is returned as output.

Thus, the formula for the context-dependent LoG machine 569 in terms of FSM operations is:

Cl o rev(Cr o[rev(LoG)])

The standard FSM composition operation must be extended to handle “*”, the phonemic symbol for runtime class 735. The composition with C process 56 replaces arcs in LoG 539 having phonemic input labels matching “*” with a collection of arcs, each arc in the collection corresponding to an input label given by a context model in the context dependent models FSM 723. Broadly speaking, therefore, the composition with C process 56 constrains the values of “*” to known permissible values, where “permission” entails being part of a context for which a context model exists.

The replacement includes a departing arc collection 561 and a returning arc collection 562.

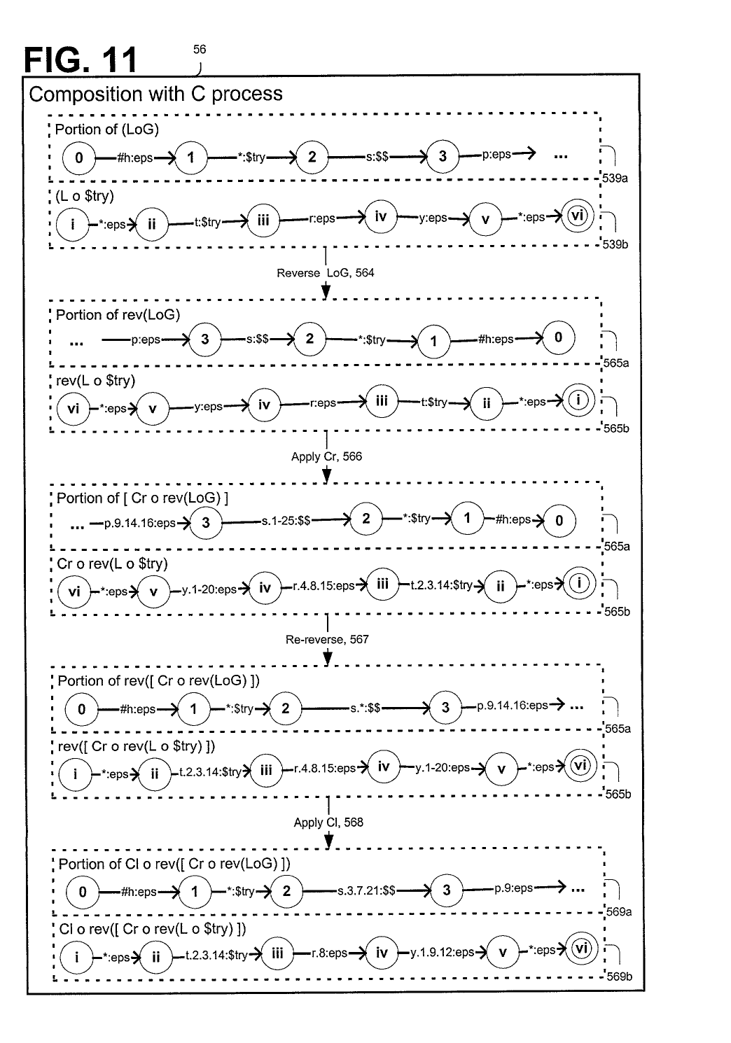

FIG. 11 shows a sequence of steps in the composition with C process 56 and the effects of the steps on two samples: a portion of an example input LoG 539, and a sample runtime grammar 32, referred to in this example by its token “$try”.

The composition with C process 56 copies the input machine 539 to a current machine FSM 565. The current machine FSM 565 is the work-in-progress version of the FSM that will be returned as the output FSM 569.

The composition with C process 56 sets the current machine FSM 565 to be the FSM reversal of the input LoG machine 569 (step 564). The composition with C process 56 then composes Cr 55 with the reversed LoG 569 (step 566). The input FSM is reversed so that it may be traversed to find right contexts without backtracking: post-reversal, the right context of the current arc is always in the portion of the machine already traversed.

The input label for an arc in LoG 569 is a phoneme, to be replaced with one or more context-dependent models. When rewriting a given arc with Cr 55 (step 566), the composition with C process 56 considers the arc's input label, as well as the input label of the previous arc (in the reversed LoG 569), which gives the right context for the current phoneme. The given arc label is then replaced with every context-dependent model 779 that matches the current phoneme and its right context. For the examples shown in FIG. 11, the input label on the arc passing from state “iii” to state “iv” is rewritten from the phoneme “r” to the context-dependent models “r.4”, “r.8”, and “r.15”. (The sequence for these is written as “r.4.8.15”.) This indicates that three models were found for the phoneme “r” having right context “y”. Similarly, the input label on the arc passing from state “iv” to state “v” is rewritten from the phoneme “y” to “y.1-20”. All models on y from “y.1” to “y.20” matched the context because the right context is “*”, which represents the border of a runtime grammar 32. Since “*” could be anything, it matches every context.

Also in composing Cr 55 with the reversed LoG 569 (step 566), the composition with C process 56 removes any homophone symbols from the current machine FSM 565 that were introduced into L by the disambiguate homophones process 731.

Next, the composition with C process 56 reverses (step 567) the current machine FSM 565 again. This second application of FSM reversal restores the original order of paths within LoG 539.

The composition with C process 56 then composes Cl 54 with the current machine FSM 565 (step 568). This traversal of the current machine FSM 565 matches a phoneme (no longer represented by a phonemic symbol, but readily apparent from the context-dependent model that has replaced it) and its left phonemic context with the context-dependent models encoded in Cl 54. The matching further constrains the context-dependent models which have replaced the phoneme; and, since constraints for both right context and left context have now been applied, the constraints are the same as would be applied by the un-factored FSM of context dependent models 723.

When both the left and right phonemic contexts of an input label are known (in triphone-based context schemes), they uniquely determine a context dependent model for the input label.

After composition of the current machine 565 with Cl to produce a new current machine 565 (step 568), the composition with C process 56 returns the current machine 565 as the context-depended LoG machine 569.

Composition with P

The grammar-to-phoneme compiler 50 uses the composition with P process 58 to include phonemic rewrite rules in the phoneme transducer that the grammar-to-phoneme compiler 50 constructs. The phonemic rewrite rules are encoded in the phonological rules FSM 722, also known as P, and include rules for alternate pronunciations. The phonemic rewrite rules can be contextual, and their contexts can cross word (and therefore runtime grammar 32) boundaries.

The transducer P 722 maps phonemes to phones, but the machine 569 returned by the composition with C process 56 has context-dependent models for input labels. However, since a phonemic symbol is readily apparent from the context-dependent model that has replaced it, the composition with P process 58 can use known FSM composition techniques.

The composition with P process 58 returns a context-dependent lexical-grammar machine 589 (not shown) to the grammar-to-phoneme compiler 50. The grammar-to-phoneme compiler 50, in turn, returns the same machine as output: the phonological and context-dependent lexical-grammar machine 59.

Transducer Combination

The transducer combination process 42 enables context-dependent recognition of input strings that cross a boundary between the main transducer 43 and a runtime transducer 44.

The transducer combination process 42 includes at least two modes: an endset transducer 45 and a subroutine transducer 60.

Endset Transducer

The endset transducer 45 creates paths across boundaries between the main transducer 43 and a runtime transducer 44, subject to context constraints, by linking arcs and states at the edge of each transducer 43 and 44 with epsilon transitions. The endset transducer 45 produces continuous paths from the main transducer 43 into the runtime transducer 44 and vice versa.

FIG. 3A shows example portions of a main transducer 43 and a runtime transducer 44. The endset transducer 45 rewrites an arc 452 in the main transducer 43 that represents a runtime transducer 44. Such an arc 452 has “*” as an input label and a token 321 as an output label. The arc 452 is not removed permanently but is routed around: the endset transducer 45 adds a temporary path using two epsilon transitions. The epsilon transitions may have a special marking (not shown in figure) to distinguish which context models they will accept.

One epsilon transition 454 goes from the main transducer 43 into the runtime transducer 44. Specifically, the epsilon transition 454 departs from the same state that arc 452 departs from and points to the state in the runtime transducer 44 after its first arc. (The first arc in the runtime transducer 44 has “*” as an input label, acting as a placeholder at the border of a dynamic grammar.)

The second epsilon transition 458 returns from the runtime transducer 44 to the main transducer 43. Specifically, the second epsilon transition 458 departs the same state in the runtime transducer 44 that a last arc departs. (Each last arc in the runtime transducer 44 has “*” as an input label, acting as a placeholder at the border of a dynamic grammar.) The second epsilon transition 458 points to the same state in the main transducer 43 that the arc 452 points to.

The endset transducer 45 adds epsilon transitions 454 and 458 subject to context constraints encoded in the context dependent models 723. For epsilon transition 454, and with regard to the path that it would enable from the main transducer 43 into the runtime transducer 44, there exists an arc 453 immediately prior to transition 454, as well as an arc 455 immediately after. The input labels of arc 453 provide a left context to the input labels of arc 455, just as the input labels of arc 455 provide a right context to the input labels of arc 453. The endset transducer 45 requires that the context requirements of both arcs 453 and 455 be satisfied before adding epsilon transition 454.

Similarly, an arc 457 exists prior to epsilon transition 458 on the return path from the runtime transducer 44 to the main transducer 43, and an arc 459 exists after. Arc 457 provides arc 459's left context, just as arc 459 provides arc 457's right context. The endset transducer 45 requires that the context requirements of both arcs 457 and 459 be satisfied before adding epsilon transition 458.

The main transducer 43 includes a main departing arc collection 421, a main returning arc collection 422, a main last arc 423, and a main first arc 424. The runtime transducer 44 includes a runtime departing arc collection 426, a runtime returning arc collection 427, a runtime last arc 428, and a runtime first arc 429.

Alternate Embodiments

A number of embodiments of the invention have been described. Nevertheless, it will be understood that various modifications may be made without departing from the spirit and scope of the invention. For example, instead of tri-phonic models of phonological context, penta-phonic and tree-based context models may be used. Instead of phoneme-based context-dependent models, context-dependent models based on phones may be used. Tokens 321 may be replaced with respective runtime grammars prior to composition. Also, the composition with L process 53 could switch the order in which it tests whether the input symbol 513 is a placeholder for a runtime class, i.e., it could perform this test after looking in L for a match. Accordingly, other embodiments are within the scope of the following claims.

What is claimed is:

1. A method for a speech recognition system, comprising:
representing a word in a first grammar in terms of context-dependent models to include cross-word context models for multiple different expansions of a placeholder in the grammar.

2. The method of claim 1, further comprising:
replacing the placeholder with a second grammar; and
expanding words of the second grammar to include cross-word context models.

3. The method of claim 2, further comprising accepting a specification of the second grammar at runtime.

4. The method of claim 2, further comprising selecting the second grammar at runtime from among a plurality of grammars, the plurality being provided at design time.

5. The method of claim 2, further comprising selecting the second grammar after design time.

6. The method of claim 3, further comprising adding a word to the second grammar at runtime.

7. A method for a speech recognition system, comprising:
representing a word in a grammar in terms of context-dependent models, to include cross-word context models matching a set of possible expansions of a placeholder in the grammar.

8. The method of claim 7, wherein the set of possible expansions includes all possible expansions of the placeholder using context-dependent models.

9. The method of claim 7, wherein the set of possible expansions includes context-dependent models.

10. A method for speech recognition, comprising:
joining a first expanded grammar and a second expanded grammar at a junction where the first expanded grammar includes a first context-dependent model whose context applies to a second context-dependent model in the second expanded grammar, and the first expanded grammar includes a third context-dependent model prepared to receive at the junction a third expanded grammar which matches the context of the third context-dependent model but which does not match the context of the first context-dependent model.

11. The method of claim 10, further comprising:
expanding the first expanded grammar from a main grammar; and
expanding the second expanded grammar from a runtime grammar.

12. The method of claim 10, further comprising:
expanding the first expanded grammar from a first runtime grammar; and
expanding the second expanded grammar from a second runtime grammar.

13. A method for constructing a speech recognition system, comprising:
representing a word in a grammar in terms of context-dependent models to include cross-word context models required for multiple different expansions of a placeholder in the grammar;
replacing the placeholder with a runtime grammar; and
expanding the words of the runtime grammar to include cross-word context models.

14. The method of claim 13, further comprising selecting the runtime grammar based on a characteristic of a speaker whose speech is to be recognized by the speech recognition system.

15. The method of claim 14, wherein the characteristic of the speaker depends on a record of the speaker's identity.

16. Software stored on machine-readable media for causing a processing system to:
represent a word in a first speech recognition grammar in terms of context-dependent models to include cross-word context models for multiple different expansions of a placeholder in the grammar
